(19) United States
(12) Patent Application Publication
(10) Pub. No.: US 2008/0048041 A1
(43) Pub. Date: Feb. 28, 2008

(54) NOTE CARDS FOR BOTTLES

(76) Inventor: Anne RILEY, Carmichael, CA (US)

Correspondence Address: GROSS & ASSOCIATES, 1415 L STREET SUITE 1000, SACRAMETO, CA, 95814, US

(21) Appl. No.: 11/466,360

(22) Filed: Aug. 22, 2006

(51) Int. Cl. G06K 19/00

(52) U.S. Cl. 235/487

(57) ABSTRACT

A card for a bottle comprising of a first and second member. The first member having a first and second tab and first, second and third positions. The second portion is integral with and disposed between the first and third portions. The first tab is disposed adjacent to the second portion and includes a plurality of orifices. The second tab is disposed adjacent to the third portion opposite the fold line between the second and third portions. The first portion has a slit operably configured to receive the second tab. The second member is a length of flexible material having first and second ends. The second member extends through each of the plurality of orifices and the first and second ends are connected forming a loop. The second member is operably configure to removably hang on the bottle when the device is in use.

### BACKGROUND OF THE INVENTION

1. Field of Invention

The present invention relates to note cards for bottles and attaching the note cards to a bottle. In particular, the present invention provides a card which can hang on a wine bottle and display a customized message or other indicia.

2. Description of Related Art

Generally, when presenting a gift, such as flowers, wine or wrapped gift boxes, the gift giver presents a card along with the gift. Conventional note cards accent the gift while personalizing the delivery and provide a place to write a private note and attach a flat object, such as a business card or a monetary gift card. When giving conventional cards they are generally attached with tape or pushed under the ribbon of the box or bouquet. The conventional card is a flat device that is designed to be placed on a supportive flat surface. The conventional card functions well in its intended environment, but it does not function well on a bottle shaped gift.

In today's fast-pace society where the average person works more than forty hours a week, eats from a carton and spends hours commuting, people re too busy to search for the perfect gift and often turn to quick and easy gift ideas. Bottles of wine are an easy and a convenient gift to give. However, the gift giver has a problem, due to the awkward shape and the material that bottles are made of conventional note cards are not practical for a bottle and do not provide a method of putting a personalized note card on a bottle such as a wine bottle.

Gift givers have another option when presenting bottles as gifts and that option is a gift bag. The gift bag is not a solution for combining the conventional note card with a bottle because the conventional note card is still separate from the bottle and can still be overlooked and left in the bottom of the gift bag. Some gift bags come with an attached 2-fold tag that does not provide the privacy that is desired in a conventional note card. It provides nothing more than a “to-from” tag. Further, the attached 2-fold tag stays with the gift bag and not with the gift bottle.

As consumers continue to give wine as gifts they will look for ways to personalize the gift; however the conventional note cards have limitations. First, conventional note cards cannot readily and easily be attached to the bottle and thereby stand a good chance of being lost. For example, if a gift giver tries to tape a note card to a bottle of wine, the tape will not stick well to the glass and the chances are that the card will fall off. Additionally, taping the card to the label is not a viable option because the label on a wine bottle is considered art and is part of the experience of drinking wine. Therefore, taping a conventional note card to the label would destroy the quality of the label when the tape is removed. Further, attempting to satisfactorily tape a conventional note card to a bottle produces an unattractive presentation and therefore is in poor taste, which may reflect badly on the gift giver.

Still, another alternative for the gift giver is to present the gift bottle in one hand and the conventional note card in the other hand. This option is awkward for the giver as well as the receiver and increases the likelihood of separation of the gift and the conventional note card

The prior art devices provide bottle tags or hangers, which are flat sheets with an orifice, wherein the neck of a bottle through the orifice to hang the tag; for example, a sale sign on a soda bottle in a store or a “to-from” tag. The structure of these conventional devices is generally hard card stock or plastic. When the conventional bottle tag is hung on a bottle, the tag sticks out or gets bent against the bottle. Further, these conventional devices do not present the aesthetic qualities of a note card.

Another deficiency with conventional bottle hangers is that they fail to hang in a manner that provides a presentable display for the gift giver or for a retailer. Conventional devices stick out, free spin or are bulky.

Additionally, the conventional tags are lacking a location for the gift giver to write a personal note with some expectation of privacy.

Further, conventional bottle hangers fail to provide a location to hold an added gift such as a gift certificate, photo or bonus check. Many business professionals present their employees or clients with gifts of wine during the holiday season and some often provide a gift certificate or a bonus check along with the wine. Many business professionals also give promotional gift bottles to clients and conventional bottle tags or hangers do not fulfill this need because they do not have a compartment to hold such items.

Another deficiency with conventional bottle tags is that the only space for placing advertising is on the exposed exterior front surface of the flat card.

As will be seen from the description below the present invention overcomes the noted deficiencies, as well as others.

### SUMMARY OF THE INVENTION

The present invention is a decorative note card in which a user or gift giver may attach securely to a bottle. The present invention includes an exterior surface on which decorative art work is placed and an interior surface where the gift giver may write a private personalize message. It is an object of the present invention to overcome the drawbacks and shortcomings of conventional note cards and bottle hangers.

The present invention provides for the gift giver a secure and decorative yet easy way for attaching a note card to a gift bottle. The present invention includes a hanging member, which is placed by the gift giver over the neck of a bottle. The hanging member allows the note card to hang in a more presentable fashion as compared to conventional bottle tags.

Further, the present invention, provides a place for the gift giver to attach a business card on the inside when the card is closed. In addition to a business card, the present invention provides a location for the gift giver to place other objects such as a store monetary gift card within the note card.

Additionally, the present invention is not limited to the attachment of business cards on the inside. In one alternative embodiment, the device provides a tabular flap, which when closed forms a concealed pocket that may be used for retaining larger flat objects such as photos, gift certificates or extended personal notes for example.

The present invention is versatile in that the present invention provides a device for a retailer to display in a fashionable means advertising on a bottle on the exposed front surface as well as side surfaces while at the same time providing to the retailer's consumers a note card for the bottle.

Additionally, for ecology minded gift givers, the present invention can be further used as an attractive bookmark and enjoyed for some time to come.

The present invention provides for a card, for a bottle, comprising a first member having a first and second tab and first, second and third portions. The second portion is integral with and disposed between the first and third portions and the portions are delineated from one another by score lines. The first tab is disposed adjacent to the second portion and includes a plurality of orifices, wherein the second tab is disposed adjacent to the third portion opposite the fold line between the second and third portions. Further, the first portion has a slit operably configured to receive the second tab. The present invention further comprises a second member, wherein the second member is a length of flexible material having a first end and a second end, and engages the first member through the plurality of orifices of the first tab, wherein the second member extends though each of the plurality of orifices and the first and second ends are connected forming a loop, wherein the second member is operably configure to removably hang on the bottle when the device is in use.

Further, the present invention provides a card device, for use with a hanging member for hanging on a bottle, which comprises a center card portion having a first surface, an opposing second surface and a top edge; a first card portion and a third card portion wherein the center card portion is disposed between the first and third card portions and wherein a plurality of folds are operably configured to facilitate folding the first and third card portions toward the opposing second surface of the center card portion. The first and third portions are releasably attachable to each other via a locking mechanism. The present invention further comprises a first tab disposed adjacent to the top edge of the center card portion, wherein the first tab includes a plurality of orifices, and, a fourth card portion, wherein the fourth card portion is disposed. adjacent to the center card portion and opposite the first tab and operably configured to fold along a score line between the center and fourth card portions forming a pocket between the opposing second surface of the center card portion and the fourth card portion.

Still further, the present invention described a hanging card, for a wine bottle, comprising a card member having a first, center and third panels. The first panel has a vertically aligned slit and a plurality of symmetrical diagonal slits, wherein the plurality of symmetrical diagonal slits are operably configured to receive corner portions of a flat object to hold the flat object adjacent to the first panel. The center panel has a first surface, a second surface and a top side, wherein the first surface has a space adapted for an indicia, and further having a first tab disposed on the top side of the center panel, wherein the first tab includes two horizontally aligned orifices having a generally rectangular shape and operably configured to receive a flat ribbon. The third panel has a second tab disposed adjacent to the third panel opposite the fold line between the center and third panels and operably configured to engage the vertically aligned slit in the first panel, wherein the center panel is disposed between the first and third panel, and wherein a plurality of folds are operably configured to facilitate folding the first and third panels over second surface of the center panel. The flat ribbon engages the first tab through the two orifices and the second member is tied to form a loop and when the device is in use the loop is hung on the bottle. When in use the device has two positions, wherein in the first position the third panel is folded over the first panel such that the device hands with the third panel resting against the bottle, and wherein in the second position the first and third panels are extended such that each of the first, center and third panels rest against the bottle.

Moreover, the present invention presents in detail a hanging card, for a bottle having a neck, which comprises a flat card having a first and second surface and a tab, wherein the tab has a plurality rectangular shaped orifices, and wherein a score line separates the flat card and the tab, such that when in use the tab is bent about the score line in a direction towards the second surface. The hanging card further comprises a hanging member having forming a loop and extending through each of the plurality of orifices. When the device is in use, the hanging member is removably hung around the neck of the bottle and the second surface is generally flush with the bottle.

These features and advantages of this invention are described in, or are apparent from the following detailed description of various exemplary embodiments of the devices and methods according to this invention.

### BRIEF DESCRIPTION OF THE DRAWINGS

Various exemplary embodiments of this invention will be described in detail, with reference to the following figures, wherein

FIG. 1A is a perspective view of a device made in accordance with the present invention shown in use on a bottle;

FIG. 1B is a side view of the device in FIG. 1A shown in use on the bottle;

FIG. 2 is a front view of the device in FIG. 1A in a first position;

FIG. 3 is a front perspective view of the device in FIG. 1A in a second position;

FIG. 4 is a rear perspective view of the device in FIG. 1A in a third position;

FIG. 5 is a top perspective view of the device in FIG. 1A in a fourth position and in use on the bottle;

FIG. 6 is a front view of an alternative embodiment of the device shown in a first position made in accordance with the present invention;

FIG. 7 is a perspective view of the device of FIG. 6 in a second position;

FIG. 8 is a prospective view of the device in FIG. 6 in a third position;

FIG. 9 is a front view of another alternative embodiment of the device in a first position made in accordance with the present invention;

FIG. 10 is a perspective view of the device of FIG. 9 in a second position;

FIG. 11 is a perspective view of the device of FIG. 9 in a third position;

FIG. 12 is a perspective view of still another alternative embodiment of the device an in a first position made in accordance with the present invention;

FIG. 13 is a perspective view of the device of FIG. 12 in a second position;

FIG. 14 is a perspective view of the device of FIG. 12 in a third position;

FIG. 15 is a perspective view of yet another alternative embodiment of the device in a first position made in accordance with the present invention;

FIG. 16 is a perspective view of the device of FIG. 15 in a second position;

FIG. 17 is a perspective view of the device of FIG. 15 in a third Position;

FIG. 18 is a perspective view of still another alternative embodiment of the device made in accordance with the present invention in use on a bottle; and,

FIG. 19 is a side view of the device in FIG. 18 in use on the bottle.

### DETAILED DESCRIPTION

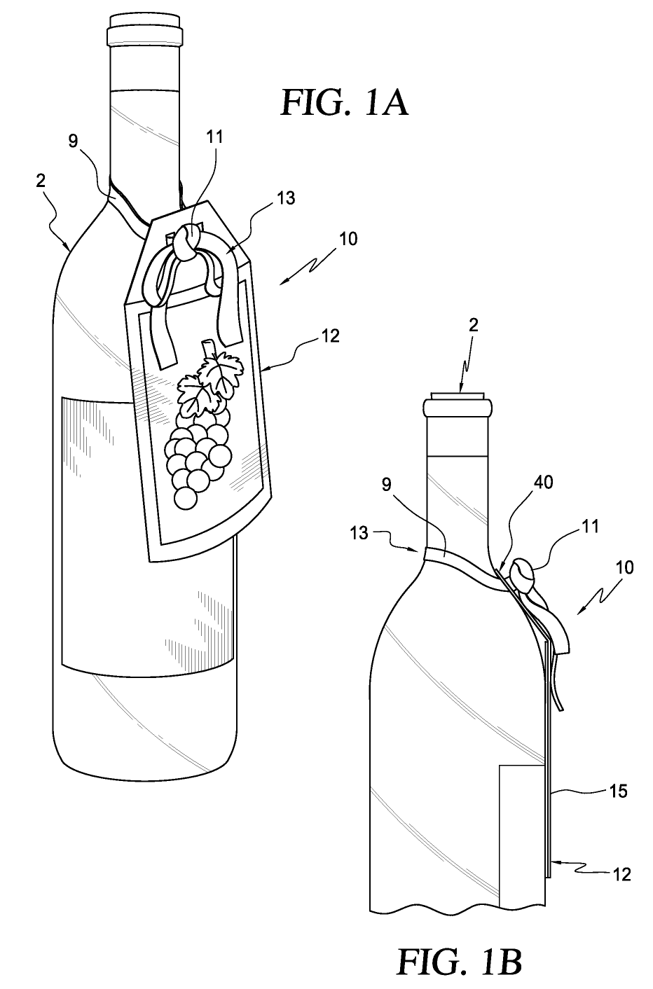

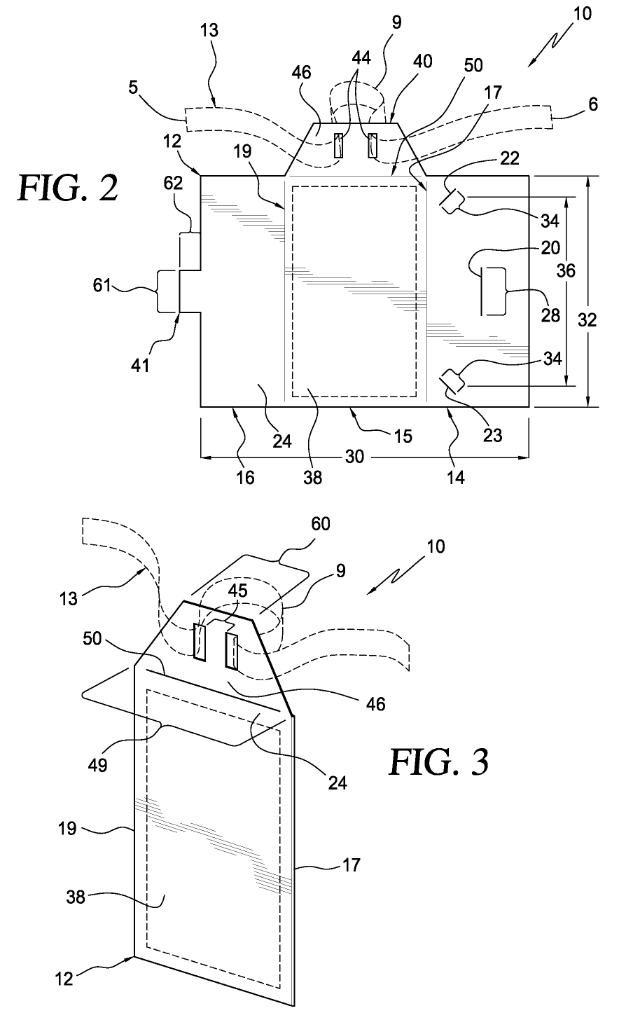

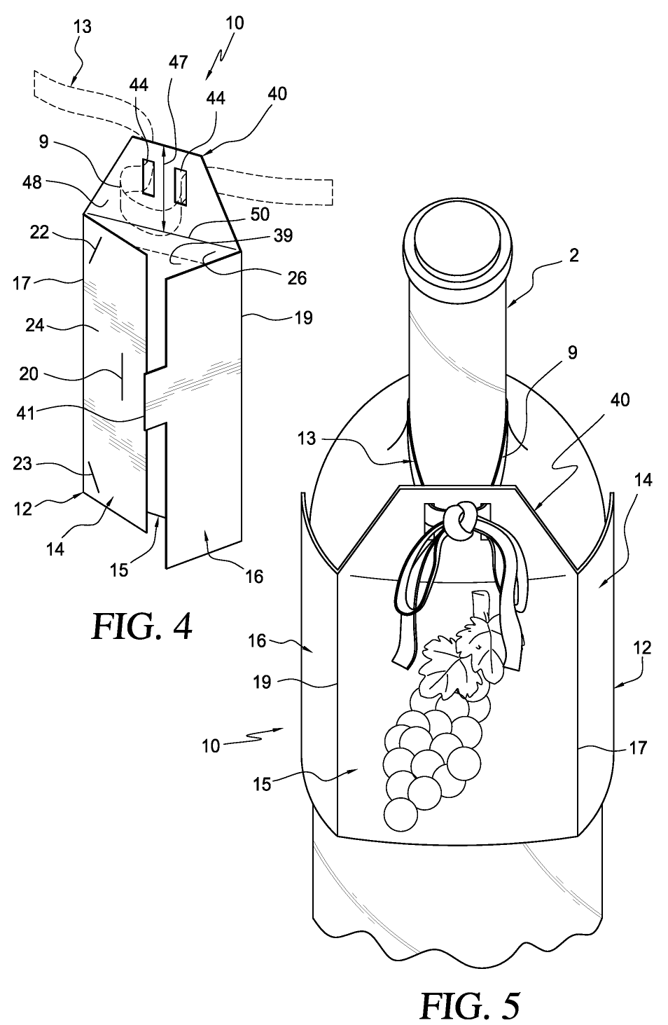

FIG. 1A is a perspective view of a device 10, made in accordance with the present invention, shown in use hanging on a bottle 2. FIG. 1B is a side view of the device 10 shown in use hanging on the bottle 2. FIG. 2 is a front view of the device 10 in a first or open position. FIG. 3 is a front perspective view of the device 10 in a second or closed position. FIG. 4 is a rear perspective view of the device 10 in a third or semi-closed position.

The device or hanging card 10, as shown in FIGS. 1A and 1B, is for hanging on the bottle 2, such as a wine bottle. The hanging card 10, as shown in FIGS. 1A and 2, includes a first member 12 and a second member 13. In the present embodiment the first member 12 is a foldable card and the second member 13 is a removable instrument for attaching the first member 12.

The second member 13 is a length of material having a first end 5 and a second end 6. The second member 13 in the present embodiment is a flat ribbon, which is operably configured to form a loop 9 and a knot 11, as shown in FIGS. 1A and 1B. The loop 9 is operably configured to fit around a neck of the bottle 2. When the device is in use, the loop 9 surrounds the neck of the bottle 2 and the second member 13 suspends the first member 12 on the bottle 2, wherein the first member 12 is between the knot 11 and the bottle 2, as can be seen in FIG. 1B. Additionally, it should be appreciated that in other various exemplary embodiments, the second member 13 could be of other materials such as, but not limited to, round ribbon, a jewelry chain or a wineglass “charm” for example.

In the present embodiment the knot 11 is a square knot that forms a bow. The knot 11 is tied such that when the use the device 10 hangs on the bottle. The knot 11 is not tied tight such that the second member is taunt to the bottle. Rather the knot 11 is tied such that the device 10 hangs freely on the bottle. Further, it should be appreciated that in other various exemplary embodiments, the second member could fastened in other ways common in the art such as, but not limited to, glue, snaps, buttons etc.

Referring now to FIG. 2, the first member 12 includes a first portion 14, a second or center portion 15 and a third portion 16; wherein the first portion or panel 14, second portion or panel 15 and third portion or panel 16 are integral. The first and second portions 14 and 15 are separated by a score line 17. The second and third portions 15 and 16 are separated by a score line 19.

Referring to FIGS. 2 through 4, the first member 12 further includes a first surface 24 and an opposing second surface 26, wherein the first surface 24 is the front of the first member 12 and the opposing second surface 26 is the back of the first member 12. When the device 10 is in the second or closed position as shown in FIG. 3, the first portion 14 folds along score line 17 such that the second surface 26 of the first portion 14 comes in contact with the second surface 26 of the second portion 15. The third portion 16 is folded along score line 19 such that the second surface 26 of the third portion 16 comes in contact with the first surface 24 of the first portion 14.

The first member 12 as shown in FIG. 2 has a generally rectangular shape with a width 30 and a height 32 such that the width 30 is oriented in a horizontal direction. In the present embodiment the width to height ratio is 0.75. However, it should be appreciated that in other various exemplary embodiments the width to height ratio can vary according to design choice. Additionally, it should be appreciated that in other various exemplary embodiments, the shape of the first member could be other than rectangular. The shape of the first member could be, for example, oval, heart shaped or shaped like a cluster of grapes.

Still referring to FIG. 2, the first portion or first panel 14, the second portion or center panel 15 and third portion or third panel 16 are also generally rectangular shaped having a width and a height and are oriented in with the height in generally a vertical direction. The first, second and third portions 14, 15 and 16 each have an equal height, which is equal to the height 32 of the first member 12. In the present embodiment the width to height ratio of the first and third portion is 0.36. However, it should be appreciated that in other exemplary embodiments the width to height ratio can vary according to design choice. The second portion 15 has a width to height ratio of 0.54. Again, it should be appreciated that in other various exemplary embodiments the width to height ratio can vary according to design choice.

The first member 12 in the present embodiment is stamped or cut from one piece of conventional card stock. However, it should be appreciated that in other various exemplary embodiments the first member could be construed from three individual portions of different material common in the art of making cards.

The first portion 14 as shown in FIGS. 2 and 4, includes a first slit 20, a second slit 22 and third slit 23, wherein each of the slits 20, 22 and 23 each slit penetrates from the first surface 24 to the second surface 26. The first slit or closing slit 20 is disposed on the first portion 14 such that the closing slit 20 is generally oriented parallel to the height of the first portion. Further, the closing slit 20 is positioned midway between the width and the height of the first portion 14. Additionally, the closing slit 20 has a length 28. The length 28 in the present embodiment is 1.4 inches (3.56 cm). However, it should be appreciated that in other various exemplary embodiments the length of the closing slit can be varied as a design choice.

The second or diagonal slit 22 has a length 34 and a center. The diagonal slit 22 is disposed on the first portion 14 such that it is generally oriented at an angle of 45 degrees below the horizontal in a direction to the score line 17.

The third or diagonal slit 23 has a length 34 and a center. The diagonal slit 23 is disposed on the first portion 14 such that it is generally oriented at an angle of 45 degrees above the horizontal in a direction to the score line 17. The center of diagonal slit 22 and center of diagonal slit 23 are separated by a distance 36 and operably configured to fit a generally flat object such as a business card or monetary gift card. The distance 36 in the present embodiment is 3.5 inches (8.89 cm). However, it should be appreciated that in other various exemplary embodiments the length of the distance between the diagonal slits 22 and 23 can be varied as a design choice.

The diagonal slits 22 and 23 are operably configured to receive a flat object such as, but not limited to, a business card or a monetary gift card. For example, a user may insert the corners of the user's business card into the diagonal slits 22 and 23 from the second surface 26 such that when the first portion 14 is folded along score line 17, the business card would be positioned between the first portion 14 and the second portion 15. Further, when the third portion 16 is folded along score line 19, the business card or monetary gift card would be restricted in place by score lines 17 and 19. Further, it should be appreciated that in order various exemplary embodiments, the diagonal slits are optional.

Referring to FIGS. 2 through 4, the second portion 15 includes a first area 38 disposed on the first surface 24, a second area 39 disposed on the second surface 26 and a first tab 40. The first area or indicia area 38 provides a location for printed indicia such as, for example, pictures or art designs. The second area 39 provides a location for the gift giver to write a personalized note, which is not open to public viewing when the first portion 14 and the third portion 16 are folded. However, it should be appreciated that in other exemplary embodiments the indicia area could be left blank for handwritten notes or user attached art.

The first tab 40 is disposed along width of the second portion 15 and includes a plurality of orifices 44, a first surface 46, and an opposing second surface 48. In the present embodiment, the first tab 40 and the second portion 15 are integral. However, it should be appreciated that in other various exemplary embodiments the first tab and second portion are not integral and may be attached by other methods common in the art, such as, but not limited, being glued together.

The tab 40 is separated from the second portion 15 by a flex area 50. In the present embodiment the flex area 50 is a score line. The tab 40 rotates about the flex area 50 in a direction toward the back surface 26 of the first member 12. It should be appreciated that in other various exemplary embodiments, the flex area could be a hinge, an accordion type fold or other type of flexible connections common in the art. Further, it should be appreciated that in other various exemplary embodiments the flex area could be an individual portion separate from the tab and second portion such as a mechanical hinge for example. A feature created by rotating the tab 40 along the flex area 50 is that the first member 12 is suspended generally parallel to the outside of the bottle 2. This allows the device 10 to hang on the bottle 2 in a presentable fashion such that the device 10 will not spin or awkwardly stick out when the device 10 is in use.

Further, the first tab 40 has a generally trapezoidal shape, wherein tab 40 has a height 47, a bottom width 49 and a top width 60. In the present embodiment the height 47 of the first tab 40 is 0.9 inches (2.29 cm), the bottom width 49 is 2.4 inches (6.1 cm) and the top width 60 is 1.1 inches (2.79 cm). It should be appreciated that in other various exemplary embodiments the first tab may have other geometric shapes and dimensions according to design choice.

As shown in FIG. 2, 3 and 4, the plurality of orifices 44 have a generally rectangular shape. The orifices 44 are disposed on the first tab 40 such that each orifice 44 is separated from each other by a distance 45. In the present embodiment, the first tab 40 has two orifices 44 and the distance 45 is 0.5 inches (1.27 cm). Further, the plurality of orifices 44 are positioned midway along the height 47. However, it should be appreciated that in other various exemplary embodiments the distance between the orifices may vary as a design choice.

The generally rectangular shape of the orifices 44 is operably configured to receive the second member 13. The first end 5 of the second member 13, as shown in FIGS. 1A through 4, is inserted through a first orifice of the plurality of orifices 44 in the direction form the first surface 46 of the tab 40 towards the second surface 48. Next, the first end 5 is inserted through a second orifice of the plurality of orifices 44 in the direction from the second surface 48 towards the first surface 46. The first and second ends 5 and 6 are then tied together to form the loop 9.

When the device 10 is in use, the second member 13 is then hung around the bottle 2, as shown in FIG. 1A. The second member 13 removably affixes the device 10 to the bottle 2, when the device 10 is in use. In the present embodiment the second member 13 is a flat ribbon. It should be appreciated that in other various exemplary embodiments the second member could be of other types of material such as, but not limited to, decorative cord or other material common in the art.

The orifices 44 are further operably configured to allow the second member 13 to lay flat in a nice presentable fashion against the first surface 46 of the first tab 40, while at the same time allowing a second member 13 to lay generally flat against the bottle 2. It should be appreciated that in other various exemplary embodiments, the orifices could be of other geometrical shapes.

Further, as shown in FIGS. 2 through 4, the bottom width 49 of the tab 40 is equal in width to the second portion 15. It should be appreciated that in other various exemplary embodiments the bottom width of the first tab could be greater than or less than the width of the second portion.

Referring again to FIG. 2, the third portion 16 includes a second tab 41. The second tab or closing tab 41 has a generally rectangular shape and is disposed on the third portion 16 such that the second tab 41 is oriented generally parallel to the height 32. However, it should be appreciated that in other various exemplary embodiments the second tab could be of other geometric shapes, such as, hexagonal, semi-circular, or trapezoidal. Further, the second tab 41 has a height 61 and a width 62. The height 61 of the second tab 41 is less than the length 28 of the first slit 20 on the first portion 14. The second tab 41 is operably configured to engage the first slit 20 when the third portion 16 and first portion 14 are folded along score lines 17 and 19 as described above. However, it should be appreciated that in other various exemplary embodiments the height and width of the second tab can be varied as a design choice.

In the present embodiment, first portion 14 is folded along score line 17 toward the second surface 26, as shown in FIG. 4. The third portion 16 is then folded along score line 19 toward the folded first portion 14. The closing slit 20 receives the closing tab 41 to keep the hanging note card 10 closed. It should be appreciated that in other various exemplary embodiments, other methods of closing the third portion to the first portion may be used such as glue, hook and loop fastener, for example.

As can be seen in FIGS. 2 and 4, the device 10 in the present embodiment has one second tab 41 disposed on the third portion 16 and one corresponding closing slit 20 disposed on the first portion 14. It should be appreciated that in other various exemplary embodiments the third portion could have a plurality of second tabs and the first portion would have an equal number of corresponding closing slits.

The user, if so desires, can write a personal note on the second area 39 of the second surface 26. Further, the user can insert a business card or a store monetary gift card into the diagonal slits 22 and 23. The user then closes the first member 12 by inserting the second tab 41 into the slit 20. The user can now insert the neck of the bottle 2 into the loop 9 and hang the device 10 on the bottle 2.

FIG. 5 is the device 10 shown in an alternative position, wherein the first portion 14 and the third portion 16 are not folded on each other. Instead, in this alternative position the first and third portions 14 and 16 are folded generally only ninety degrees, such that when in use the first and third portions 14 and 16 extend along the sides of the bottle 2. In this alternative position, the device 10 may be used by a retailer who places the device 10 on bottles to be purchased by a consumer. The retailer may use the entire first surface 24 of the first member 12 for indicia, advertising or other information to further describe the product. Thus the retailer is providing the consumer with details about the product and a note card when the bottle is purchased. The consumer removes the device 10 from the bottle, writes a note on the opposing second surface 26, closes the device 10 and re-hangs the device 10 on the bottle 2.

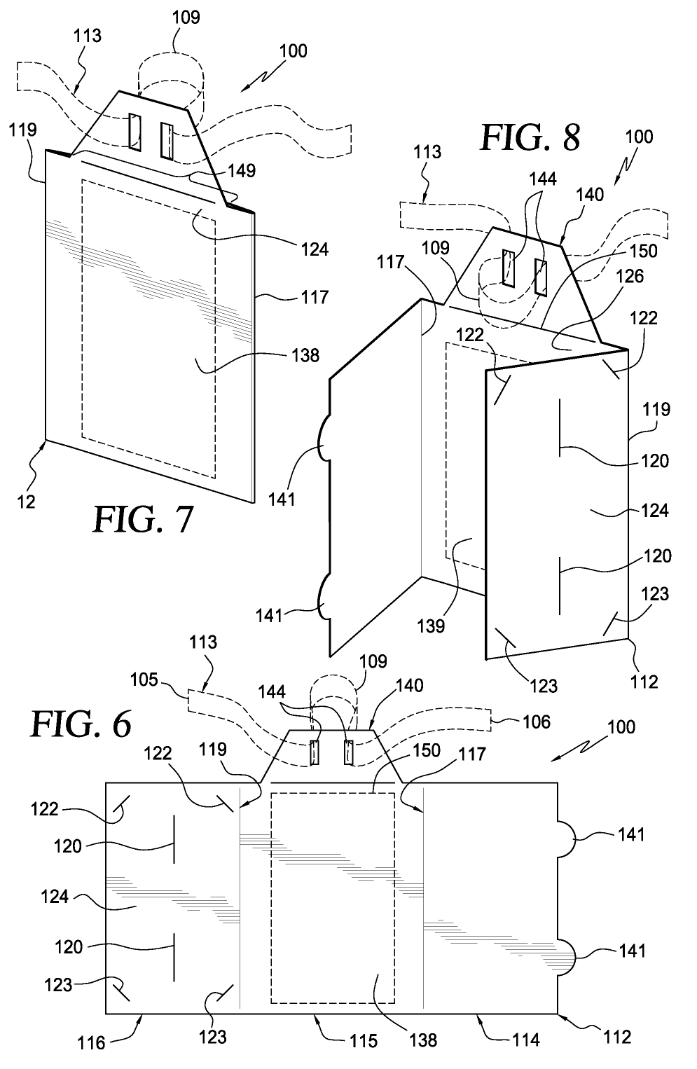

FIG. 6 is a front view and FIGS. 7 and 8 are perspective views of a device 100. The device 100 is an alternative exemplary embodiment of the device 10, made in accordance with the present invention. The device 100 is similar to device 10 as described above in that it has a first member 112, and a second member 113. The device 100, like the device 10 also includes, a first portion 114, a second portion 115, a third portion 116, a first score line 117, and a second score line 119. The device 100 further includes a first surface 124, a second surface 126, a first tab 140, a flex area 150 and a plurality of orifices 144.

The device 100 is different from the device 10 in that the device 100 has a two closing slits 120 disposed on the third portion 116 and two closing tabs 141 disposed on the first portion 114. Further, the closing tabs 141 on the device 100 have a generally semi-circular shape. Still further, the device 100 includes an additional diagonal slit 122 and an additional diagonal slit 123 for a total of four diagonal slits. Still further, the device 100 is different from device 10 in that the first tab 140 has a bottom width 149 that is not equal to a width of the second member 115. The feature of the additional diagonal slit 122 and the additional diagonal slit 123 allow the user to insert all corners of a monetary gift card into the device 100 for better security.

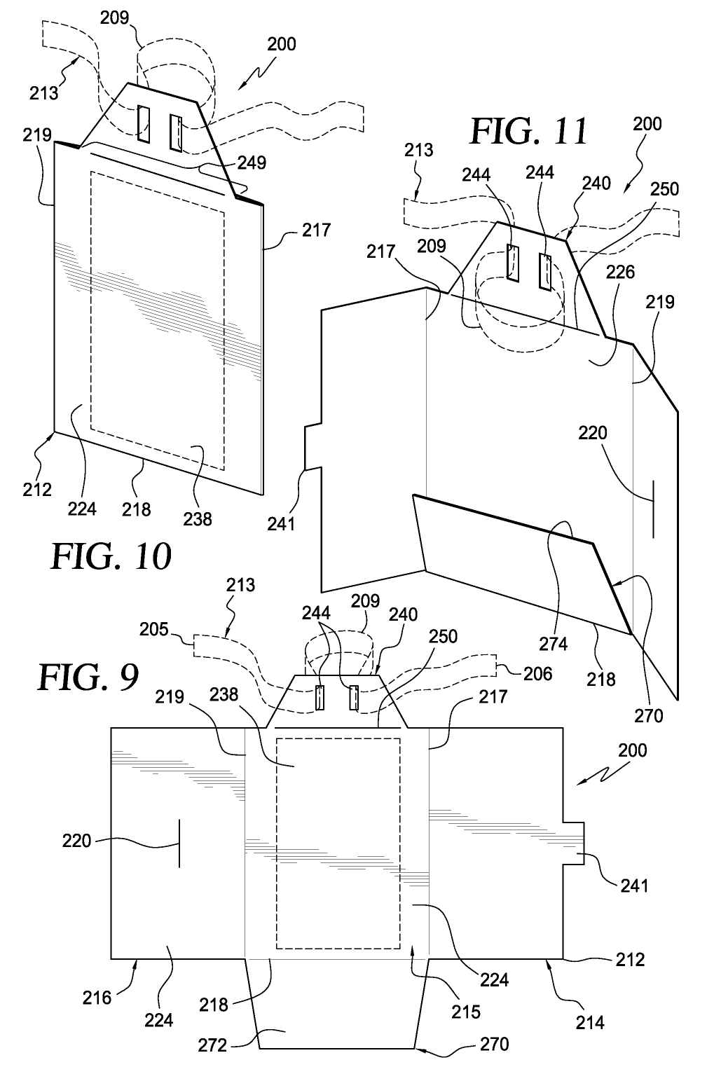

FIG. 9 is a front view and FIGS. 10 and 11 are perspective views of a device 200. The device 200 is an alternative exemplary embodiment of the device 10, made in accordance with the present invention. The device 200 is similar to device 10, as described above in that the device 200 includes a first member 212 and a second member 213. The device 200 like device 10 also includes a first portion 214, a second portion 215, a third portion 216, a first score line 217, and a second score line 219. The device 200 further includes a first surface 224, a second surface 226, a first tab 240, a flex area 250 and a plurality of orifices 244.

The device 200 is different from the device 10 in that the device 200 has a closing slit 220 disposed on the third portion 216 and a closing tab disposed on the first portion 214. Still further, the device 200 is difference from device 10 in that the first tab 240 has a bottom width 249 that is not equal to a width of the second member 215.

Another difference in device 200 is that the device 200 includes an additional fourth portion 270. The fourth portion 270 has a generally trapezoidal shape and is disposed along a third score line 218 adjacent the second portion 215.

The fourth portion 270 includes a first surface 272 and a second surface 274, as shown in FIGS. 8 and 10. The fourth portion 270 is operably configured to fold along the score line 218 such that when the fourth portion 270 is folded, the second surface 274 of the fourth portion is against the second surface 226 of the first member 212.

In folding the device 200, the fourth portion 270 is folded first then the first portion 214, followed by the third portion 216. The fourth portion 270 creates a pocket between the second portion 215 and the fourth portion 270 bounded by the fold lines 217 and 219 as shown in FIG. 11. The pocket formed between the second and fourth portions 215 and 270 is a location that the user can place generally flat objects such as, but not limited to, business cards, monetary gift cards or gift certificates. An advantage of the device 200 over the device 10 is that the pocket formed by the fourth portion 270 allows the user to place flat objects larger than a business card.

Another difference in the device 200 is that unlike device 10, the device 200 does not include any diagonal slits for holding generally flat objects such as business cards.

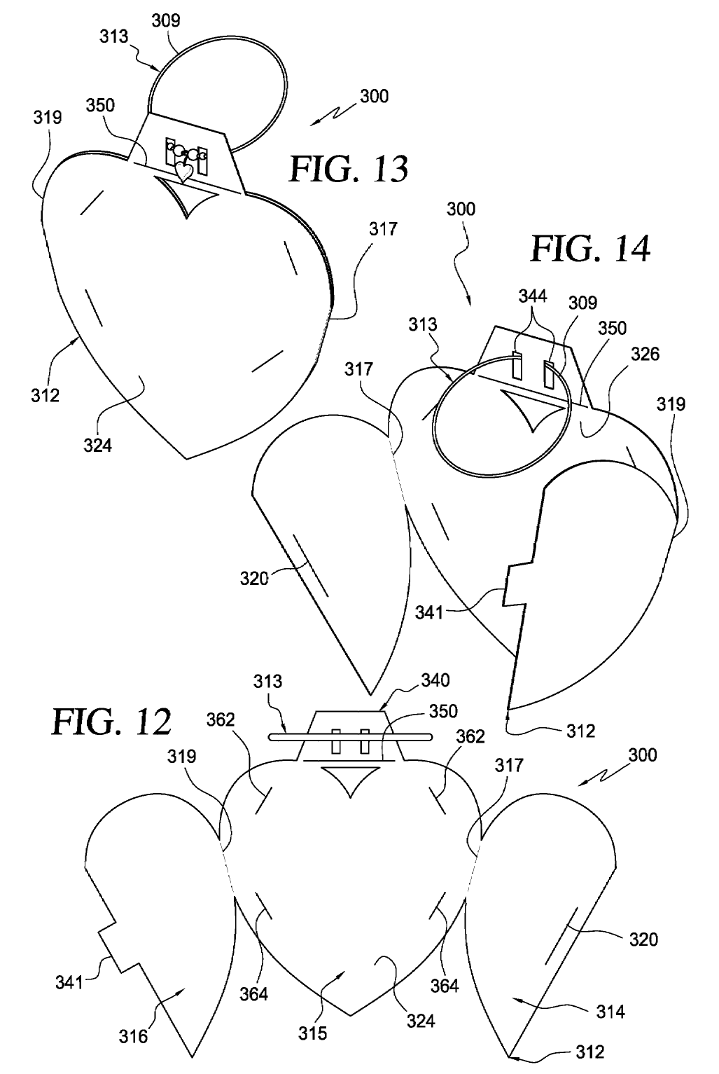

Now referring to FIG. 12, which is a front view and FIGS. 13 and 14, which are perspective views of a device 300. The device 300 is another alternative exemplary embodiment of the device 10, made in accordance with the present invention. The device 300 is similar to device 10, as described above in that the device 300 includes a first member 312 and a second member 313. The device 300 like device 10 also includes a first portion 314, a second portion 315, a third portion 316, a first score line 317, and a second score line 319. The device 300 further includes a first surface 324, a second surface 326, a closing slit 320, a first tab 340, a flex area 350, a closing tab 341 and a plurality of orifices 344.

A difference in device 300 when compared to device 10 is that the second member 313 of the device 300 is a flexible wire. In this embodiment the flexible wire 313 is a wineglass charm, as shown in FIG. 13. The use of the wineglass charm 313 provides an additional gift that the user can give to the person receiving the bottle 2.

An additional difference in device 300 is that the device 300 has a generally heart shape, as can been seen in FIG. 12 when all the portions 314, 315 and 316 are folded. Another difference in the device 300 is that the second portion 315 includes plurality of pairs of slits 362 and 364 operably configured to hold a business card or monetary gift card.

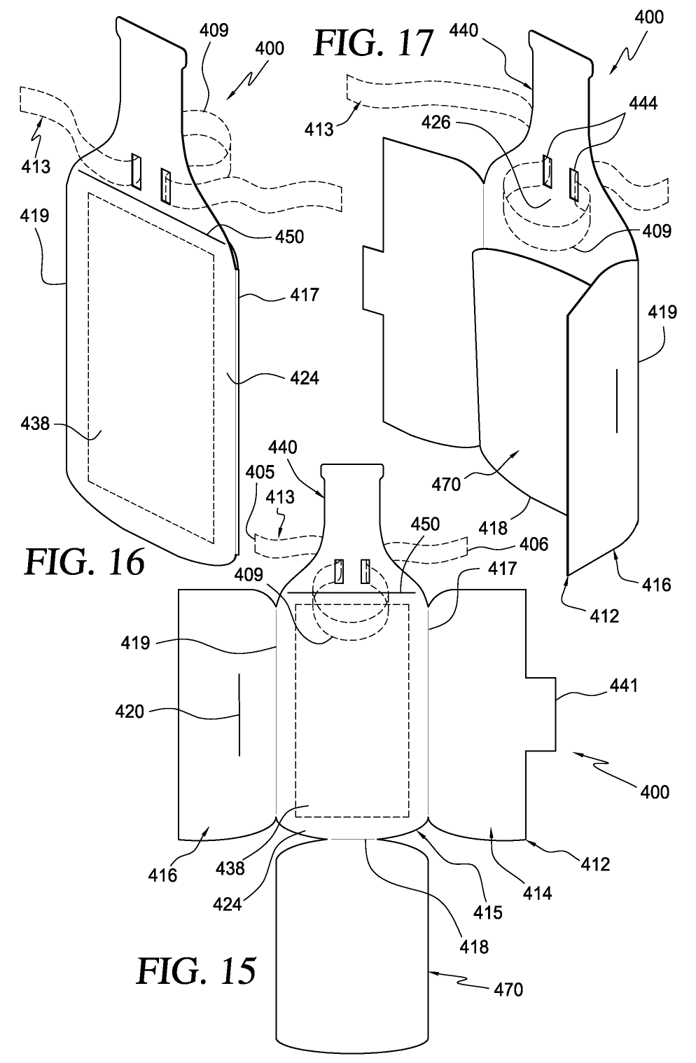

Now referring to FIGS. 15, which is a front view and FIGS. 16 and 17, which are perspective views of a device 400. The device 400 is another alternative exemplary embodiment of the device 200, made in accordance with the present invention. The device 400 is similar to device 200, as described above in that the device 400 includes a first member 412 and a second member 413. The device 400 like device 200 also includes a first portion 414, a second portion 415, a third portion 416, a first score line 417, and a second score line 419. The device 400 further includes a first surface 424, a second surface 426, a closing slit 420, a first tab 440, a flex area 450, a closing tab 441 and a plurality of orifices 444. Another similar feature in device 400 with that of device 200 is the inclusion of a fourth portion 470 and a fold line 418.

A difference between device 400 and device 200 is that device 400 is generally in the shape of a bottle, as can be seen in FIG. 16, when all the portions 414, 415, 416 and 470 are folded.

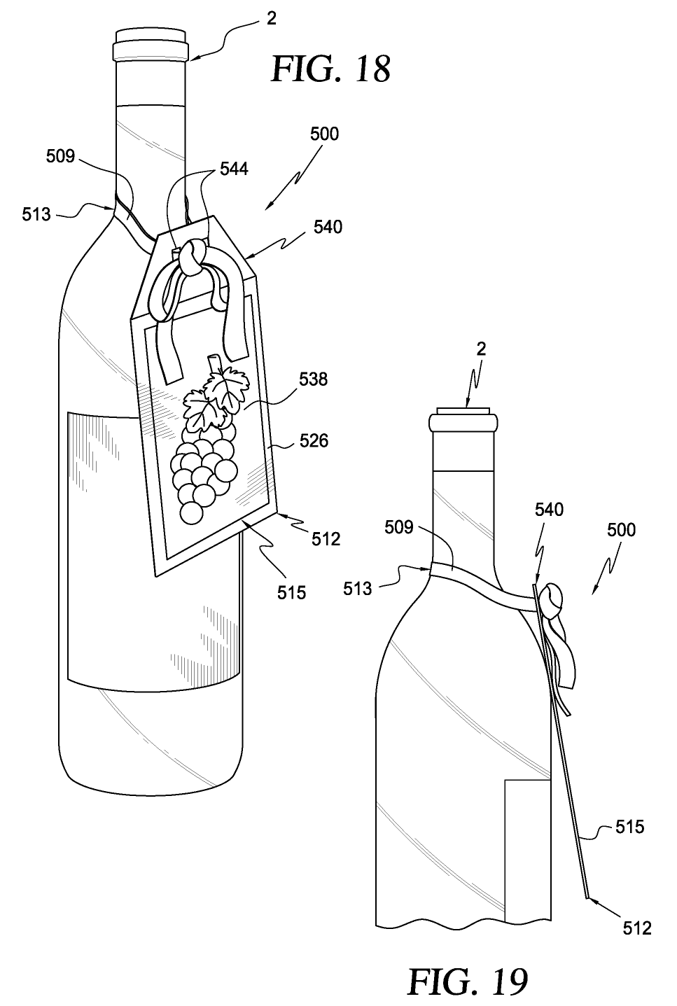

FIG. 18 is a top perspective view of a device 500. The device 500 is yet another alternate exemplary embodiment of the device 10, made in accordance with the present invention. The device 500 is similar to device 10, as described above in that the device 500 includes a first member 512 and a second member 513. The device 500 like device 10 also includes a first surface 524, a second surface 526, an indicia area 538, a generally trapezoidal shaped tab 540, a flex area 550 and a plurality of generally rectangular shaped orifices 544.

A difference between device 500 and the device 10 is that the device 500 does not include first and third portions. The device 500 is a reduced version of the device 10. The indicia area 538 provides an area for information or art work. The second surface 526 provides an area for the user to a quick note and indicate who the bottle is for.

Another difference in the device 500 is that the device 500 does not have a flex area as does device 10. Without the flex area, the tab 540 does not bend towards the neck of the bottle 2. The first member 512 remains generally straight, as shown in FIG. 19.

Additionally, it is contemplated by the present invention that any of the devices 10, 100, 200, 300 and 400 may be die cut from a single card stock. Further, it should be appreciated that in other various exemplary embodiments, other decorative shapes may be used in making the device 10.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes many be made without departing from the spirit and scope of the invention.

What is claimed is:

1. A card, for a bottle, comprising:
a first member having a first and second tab and first, second and third portions, wherein the second portion is integral with and disposed between the first and third portions and the portions are delineated from one another by score lines, wherein the first tab is disposed adjacent to the second portion and includes a plurality of orifices, wherein the second tab is disposed adjacent to the third portion opposite the fold line between the second and third portions, and wherein the first portion has a slit operably configured to receive the second tab, and,
a second member, wherein the second member is a length of flexible material having a first end and a second end, and engages the first member through the plurality of orifices of the first tab, wherein the second member extends through each of the plurality of orifices and the first and second ends are connected forming a loop, and wherein the second member is operably configure to removably hang on the bottle when the device is in use.

2. The card for a bottle, as recited in claim 1, wherein first portion includes a plurality of diagonal slits and the plurality of diagonal slits are operably configured to secure a flat object.

3. The card for a bottle, as recited in claim 1, wherein the second tab has two horizontally aligned orifices having a generally rectangular shape.

4. The card for a bottle, as recited in claim 1, further comprising a fourth portion, wherein the forth portion is disposed adjacent to the second portion and opposite the first tab, and wherein the fourth portion is operably configured to fold along a score line between the second and fourth portions.

5. The card for a bottle, as recited in claim 1, wherein the second member is a flat ribbon.

6. The card for a bottle, as recited in claim 1, wherein the second portion further includes a first surface and the first surface has a space adapted for an indicia.

7. The card for a bottle, as recited in claim 1, wherein the first, second and third portions are integral.

8. A card device, for use with a hanging member for hanging on a bottle, comprising:
a center card portion having a first surface, an opposing second surface and a top edge,
a first card portion and a third card portion wherein the center card portion is disposed between the first and third card portions and wherein a plurality of folds are operably configured to facilitate folding the first and third card portions toward the opposing second surface of the center card portion, and wherein the first and third portions are releasably attachable to each other via a locking mechanism;
a first tab disposed adjacent to the top edge of the center card portion, wherein the first tab includes a plurality of orifices; and,
a fourth card portion, wherein the fourth card portion is disposed adjacent to the center card portion and opposite the first tab and operably configured to fold along a score line between the center and fourth card portions forming a pocket between the opposing second surface of the center card portion and the fourth card portion.

9. The card device, as recited in claim 8, wherein the first tab has two horizontally aligned orifices having a generally rectangular shape.

10. The card device, as recited in claim 8, wherein first card portion includes a plurality of diagonal slits and the plurality of diagonal slits are operably configured to secure a flat object.

11. The card device, as recited in claim 10, wherein the flat object is a monetary gift card.

12. The card device, as recited in claim 8, wherein the first surface includes a space adapted for an indicia.

13. The card device, as recited in claim 8, wherein the first, center, third and fourth card portions are integral.

14. The card device, as recited in claim 8, wherein the center card portion has a shape of a wine bottle.

15. The card device, as recited in claim 8, wherein the locking mechanism comprises a second tab disposed on the third card portion and a slit disposed on the first card portion and the second tab is operably configured to engage the slit.

16. A hanging card, for a wine bottle, comprising:
a card member having a first, center and third panels and a flat ribbon;
the first panel having a vertically aligned slit and a plurality of symmetrical diagonal slits, wherein the plurality of symmetrical diagonal slits are operably configured to receive corner portions of a flat object to hold the flat object adjacent to the first panel;
the center panel having a first surface, a second surface and a top side, wherein the first surface has a space adapted for an indicia, and further having a first tab disposed on the top side of the center panel, wherein the first tab includes two horizontally aligned orifices having a generally rectangular shape and operably configured to receive the flat ribbon;
the third panel having a second tab disposed adjacent to the third panel opposite the fold line between the center and third panels and operably configured to engage the vertically aligned slit in the first panel, wherein the center panel is disposed between the first and third panel, and wherein a plurality of folds are operably configured to facilitate folding the first and third panels over second surface of the center pane, and wherein the flat ribbon engages the first tab through the two orifices and the second member is tied to form a loop and when the device is in use the loop is hung on the bottle; and
wherein when in use the device has two positions, wherein in the first position the third panel is folded over the first panel such that the device hangs with the third panel resting against the bottle, and wherein in the second position the first and third panels are extended such that each of the first, center and third panels rest against the bottle.

17. The hanging card, as recited in claim 16, wherein the flat object is a business card.

18. The hanging card, as recited in claim 16, further comprising a fourth panel, wherein the forth panel is disposed adjacent to the center panel and opposite the first tab and operably configured to fold along a fold line between the second and fourth panels forming a pocket between second surface of the center panel and the fourth panel, wherein a flat object may be placed.

19. The hanging card, as recited in claim 16, wherein the first, second and third panels are integral.

20. A hanging card, for a bottle having a neck, comprising:
a flat card having a first and second surface and a tab, wherein the tab has a plurality of generally rectangular shaped orifices, and wherein a score line separates the flat card and the tab, such that when in use the tab is bent about the score line in a direction towards the second surface;
a hanging member having a loop and extending through each of the plurality of orifices; and,
wherein when the device is in use, the hanging member is removably hung around the neck of the bottle and the second surface is generally flush with the bottle.

21. The hanging card, as recited in claim 20, wherein the first surface includes an area for indicia.

22. The hanging card, as recited in claim 20, wherein the hanging member is a flat length of ribbon.

23. The hanging card, as recited in claim 20, wherein the hanging member is a wineglass charm.
